(19) United States
(12) Patent Application Publication
(10) Pub. No.: US 2007/0115209 A1
(43) Pub. Date: May 24, 2007

(54) Luminance control apparatus for light emitting device

(75) Inventor: Yasushi Maejima, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/598,639

(22) Filed: Nov. 14, 2006

(30) Foreign Application Priority Data
Nov. 24, 2005 (JP) 2005-338757

(51) Int. Cl. G09G 3/14

(52) U.S. Cl. 345/46

(57) ABSTRACT

A luminance control apparatus for a backlight of a display device in a vehicle has a first transistor and a second transistor connected to the backlight. The first transistor is controlled by pulse-width modulation control, and the second transistor is controlled to supply a low level current at nighttime and a high level current at daytime under a condition that the first transistor is ON. The duty ratio of the first transistor is varied over a full range from 0% to 100% at the nighttime, while the duty ratio of the same is varied only in a partial range at the daytime.

### CROSS REFERENCE TO RELATED APPLICATION

This application is based on and incorporates herein by reference Japanese Patent Application No. 2005-338757 filed on Nov. 24, 2005.

### FIELD OF THE INVENTION

The present invention relates to a luminance control apparatus for a light emitting device and, more particularly, to an apparatus that improves luminance resolution of a light emitting device.

### BACKGROUND OF THE INVENTION

As one method for controlling a luminance of a light emitting device such as a light emitting diode, a current supplied to the light emitting device is increased or decreased as disclosed in JP 2004-281922A. This current control is used for light emitting diodes used as a backlight of a liquid crystal display. In this current control, a brightness detecting device is provided to detect brightness of a surrounding area, and the backlight (light emitting diodes) is driven to emit more light as the detected brightness increases. The amount of light emission is adjustable manually by a user.

As another method for a luminance control, a current supplied to the light emitting device is controlled by pulse-width modulation (PWM). This PWM control is, as disclosed in JP 2004-281349A for instance, combined with a cycle period control. If the luminance is controlled by only the PWM control in high resolution, the pulse width must be modulated finely or in fine steps. That is, the amount of each pulse width change must be small as much as possible. If the cycle period control is combined to the PWM control and the cycle period of PWM control is lengthened, the luminance control can be attained with high resolution without modulating the pulse width in fine steps.

If a light emitting device is used as a backlight of a display in a vehicle, the luminance of the backlight must be differentiated between daytime and nighttime. That is, the luminance at nighttime must be decreased to be lower than that of the daytime. The luminance is finely adjustable by a user at both daytime and nighttime.

A light emitting device such as light emitting diodes changes hue in correspondence to the current supplied thereto. Therefore, it is difficult to control the luminance without changing the hue of the emitted light in the case of the current control. On the other hand, no hue change is caused in the case of the PWM control. Therefore, it is proposed to differentiate the luminance of the light emitting device at daytime and nighttime by the PWM control while maintaining the current unchanged.

FIG. 3 shows luminance controllable ranges in the case of controlling the luminance between the daytime and the nighttime by only the PWM control and without the current control. So far as the current is maintained unchanged, the luminance increases proportionately as the duty ratio increases. Since the luminance at daytime must be higher than that at the nighttime, the duty ratio at the daytime is set to be in a relatively high duty ratio range and the duty ratio at the night time is set to be in a relatively low duty ratio range. These two ranges may or may not overlap each other.

Human eyes are more sensitive to luminance changes in the darker surrounding. Therefore it is preferred to set the luminance more finely, that is, to set the luminance in higher resolution, in the nighttime than in the daytime.

In the case that the luminance is controlled by only the PWM control, it is necessary to allow the duty ratio to vary in more steps within the nighttime duty ratio range. As such each change amount of the pulse width must be set small. To attain such a small change, a higher performance CPU is necessitated. This results in increased costs.

If the cycle period control is combined to the PWM control, the luminance control in the low luminance range can be attained with high resolution. If a user is allowed to vary the setting of the luminance, the luminance control cycle period is varied in the end. This variation in the luminance control cycle period may cause imbalance between the image display cycle period of a display screen and the luminance control cycle period of the backlight. As a result, noises may appear on the display screen.

If the current is decreased, the luminance change range is narrowed. As a result, the amount of each luminance change width corresponding to one pulse width step is also decreased. Thus, it becomes possible to set the luminance with high resolution. In this instance, however, a maximum luminance is also decreased and hence sufficient luminance in the daytime may not be provided.

The above disadvantages arise not only in the backlight using the light emitting device but also in an apparatus, which is required to control the luminance with high resolution in both the high luminance range and the low luminance range.

### SUMMARY OF THE INVENTION

The present invention therefore has an object to provide a luminance control apparatus for a light emitting device, the apparatus being capable of setting a luminance in high resolution in a low luminance range while maintaining a high luminance.

According to one aspect of the present invention, a luminance control apparatus is provided for a light emitting device. The apparatus has a switching device for supplying a current to the light emitting device when turned on, a pulse-width modulation circuit for turning on and off the switching device with a variable duty ratio determined by a pulse-width modulation, and a current control circuit for changing the current supplied to the light emitting device to a low level and a high level that are different from each other.

### BRIEF DESCRIPTION OF THE DRAWINGS

The above and other objects, features and advantages of the present invention will become more apparent from the following detailed description made with reference to the accompanying drawings. In the drawings:

FIG. 1 is a circuit diagram showing a luminance control apparatus according to an embodiment of the present invention;

FIG. 2 is a graph showing a luminance control range of a light emitting diode used in the first embodiment; and

FIG. 3 is a graph showing a luminance control range, in which luminance between a daytime and a nighttime is differentiated by only a PWM control while maintaining the current unchanged.

### DETAILED DESCRIPTION OF THE EMBODIMENT

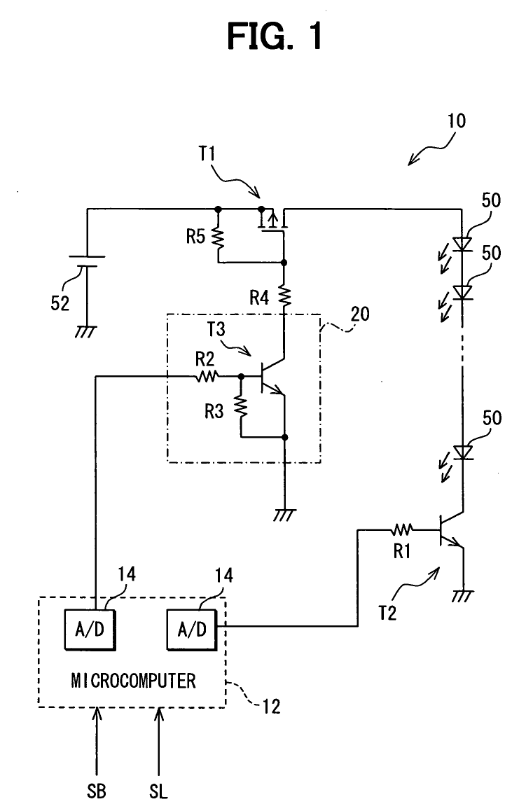

Referring to FIG. 1, a luminance control apparatus 10 is constructed to control a luminance of series-connected light emitting diodes (LEDs) as a light emitting device 50. The LEDs may be connected in parallel in part. The device 50 is used as a backlight of a liquid crystal display device for a vehicle.

The apparatus 10 is constructed with a first transistor T1, a second transistor T2, a microcomputer 12 and a driver circuit 20. The first transistor T1 is a normally-off type P-MOSFET and operates as a switching device. The source and the drain of the FET are connected to a vehicle battery 52 and the light emitting device 50, respectively. The second transistor T2 is a bipolar type. The collector, the emitter and the base are connected to the light emitting device 50, the ground and the microcomputer 12 through a resistor R1, respectively.

The driver circuit T3 includes a third transistor T3, which is a bipolar type, a resistor R2 and a resistor R3. The resistor R2 is connected to the base of the third transistor T3 and the microcomputer 12. The resistor R3 is connected at one end to the resistor R2 and the base of the third transistor T3. The resistor R3 is connected at the other end to the emitter of the third transistor T3 and the ground. The collector of the third transistor T3 is connected to the gate of the first transistor T1 through a resistor R4. A resistor R5 is connected to the resistor R4 and the gate of the first transistor T1. The resistor 5 is also connected to the source of the first transistor T1 and the battery 52.

The microcomputer 12 includes a CPU, a ROM, a RAM, and I/O port, which are not shown, and A/D conversion circuits 14. The microcomputer 12 is applied with a light signal SL indicating ON/OFF of vehicle lights and a luminance setting signal SB indicating a user's setting of luminance. The microcomputer 12 executes a control program stored in the ROM while utilizing a temporary storage function of the RAM. The microcomputer 10 thus produces output signals to the driver circuit 20 and the second transistor T2 through the A/D conversion circuits 14, respectively, thereby to control the luminance of the light emitting device 50.

In the luminance control apparatus 10 constructed as above, the microcomputer 12 checks based on the light signal SL whether the vehicle lights are ON indicating that it is the nighttime. If the lights are ON, the microcomputer 12 produces the output signal to the base of the second transistor T2 so that the current supplied to the light emitting device 50 is at a low current level CL under a condition that the first transistor T1 is ON. If the lights are OFF indicating that it is the daytime, the microcomputer 12 produces the output signal to the base of the second transistor T2 so that the current supplied to the light emitting device 50 is at a high current level CH (>CL) under a condition that the first transistor T1 is ON. Thus, the microcomputer 12 and the second transistor T2 form a current control circuit, which controls the current level to either high or low.

Since the light emitting device 50 has a characteristic of changing the hue in correspondence to the current level, the hue of the light emitted from the device 50 differs between the cases of high current level CH (daytime) and low current level CL (nighttime). This hue change due to difference in the current level does not become critical, if color of the image display is set to differ between the daytime and the night time.

The microcomputer 12 also determines the duty ratio based on the luminance setting signal SB and produces the output signal to the driver circuit 20. This output signal is in the pulse signal form having the determined duty ratio. The driver circuit 20 amplifies this pulse signal to a level sufficient to drive the first transistor T1 and applies the amplified signal to the base of the first transistor T1. The first transistor T1 turns on and off when the pulse signal is high and low, respectively. The microcomputer 12 and the driver circuit 20 thus form a pulse-width modulation circuit.

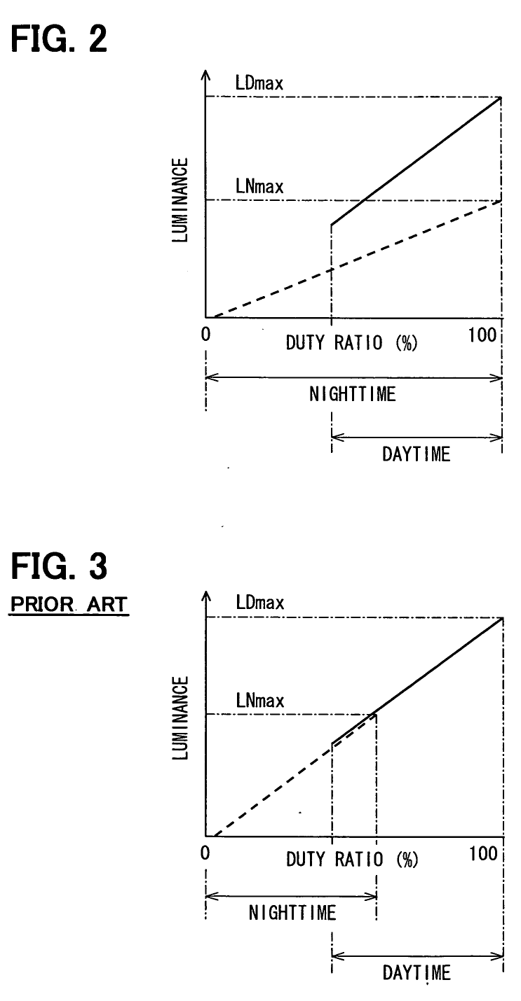

As the current supplied to the second transistor T2 is higher at daytime than at nighttime (CH>CL), a maximum luminance LDmax of the light device 50 at the daytime is higher than a maximum luminance LNmax at the nighttime as shown in FIG. 2. The maximum luminances LDmax and LNmax in this embodiment (FIG. 2) are set to be equal to those in the prior art (FIG. 3).

Further, the duty ratio of the pulse signal is set to vary from 0% to 100% at nighttime in this embodiment as shown in FIG. 2. Therefore, even if the amounts of each change in the pulse widths are limited to be the same between the embodiment and the prior art due to the use of the same microcomputer, the pulse width can be modulated more finely, that is, in higher resolution, at the nighttime than in the prior art, in which the duty ratio control range is limited to be from 0% to about 60%. It is noted that the duty ratio control for the daytime in the embodiment is the same as in the prior art.

In the embodiment, a high luminance of the light emitting device 50 is attained by driving the first transistor T1 with 100% duty ratio while supplying the current of high level CH through the second transistor T2. Further, the luminance of the light emitting device 50 is linearly varied between a small luminance range from 0 to LNmax by driving the first transistor T1 with the varying duty ratio (0% to 100%) while supplying the current of low level CL through the second transistor T2. Thus, the luminance resolution of the light emitting device 50 at the night time is enhanced. Further, the amount of each change in the PWM control is increased in the embodiment relative to the amount of each change in the case of controlling the luminance only by the pulse-width modulation without changing the current supplied by the second transistor T2. Therefore, the microcomputer 12 need not be a high performance type, thus reducing costs of the luminance control apparatus 10.

The above embodiment may be modified in many ways. For instance, the luminance of the light emitting device 50 may be automatically adjusted by detecting the brightness of the surrounding area.

What is claimed is:

1. A luminance control apparatus for a light emitting device, the apparatus comprising:
a switching device for supplying a current to the light emitting device when turned on;
a pulse-width modulation circuit for turning on and off the switching device with a variable duty ratio determined by a pulse-width modulation; and
a current control circuit for changing the current supplied to the light emitting device to a low level and a high level that are different from each other.

2. The luminance control apparatus according to claim 1, wherein:
the light emitting device is provided as a backlight of a display device in a vehicle; and
the current control circuit changes the current to the low level and the high level at nighttime and daytime, respectively.

3. The luminance control apparatus according to claim 2, wherein:
the pulse-width modulation circuit sets the duty ratio to vary in different ranges such that the range at the nighttime is wider than that at the daytime.

4. The luminance control apparatus according to claim 2, wherein:
the duty ratio at the nighttime varies from about 0% to about 100%.

5. The luminance control apparatus according to claim 1, wherein:
the light emitting device is provided as a backlight of a display device in a vehicle; and
the pulse-width modulation circuit sets the duty ratio to vary in different ranges such that the range at nighttime is wider than that at daytime.

6. A luminance control apparatus for a light emitting device in a vehicle, the apparatus comprising:
a first transistor connected in series with the light emitting device;
a second transistor connected in series with the light emitting device; and
a control means for controlling the first transistor with a variable duty ratio, and controlling the second transistor to supply a variable level current under a condition that the first transistor is in an ON condition.

7. The luminance control apparatus according to claim 6, wherein:
the light emitting device is a backlight for a display device in the vehicle;
the variable level current is set to a low level during nighttime and to a high level higher than the low level during daytime; and
the variable duty ratio is set to vary substantially over a full range of duty ratio at the night time and to vary only a part of the full range of the duty ratio at the daytime.
